(19) United States
(12) Patent Application Publication
(10) Pub. No.: US 2026/0188582 A1
(43) Pub. Date: Jul. 2, 2026

(54) MULTILAYER ELECTRONIC COMPONENT

(71) Applicant: SAMSUNG ELECTRO-MECHANICS CO., LTD., Suwon-si (KR)

(72) Inventors: Hong Gi KIM, Suwon-si (KR); Jun Young LEE, Suwon-si (KR); Ji Won LEE, Suwon-si (KR); Byeong Hyeop HA, Suwon-si (KR); Jin Il KANG, Suwon-si (KR); Jin Man KIM, Suwon-si (KR); Jong Hyeon PARK, Suwon-si (KR); Kwang Youl LEE, Suwon-si (KR)

(73) Assignee: SAMSUNG ELECTRO-MECHANICS CO., LTD., Suwon-si (KR)

(21) Appl. No.: 19/435,857

(22) Filed: Dec. 30, 2025

(30) Foreign Application Priority Data
Dec. 31, 2024 (KR) 10-2024-0201938

(51) Int. Cl. H01G 4/224; H01G 4/12; H01G 4/232; H01G 4/30; H01G 13/00

(52) U.S. Cl. CPC H01G 4/224; H01G 4/12; H01G 4/30; H01G 4/232; H01G 13/003

(57) ABSTRACT

A multilayer electronic component comprises a capacitor including a ceramic body including a dielectric layer and internal electrodes alternately disposed with the dielectric layer interposed therebetween, and an external electrode disposed on the ceramic body and connected to the internal electrodes, and an organic layer disposed to cover at least a portion of an external surface of the capacitor and including a cross-linked polymer including one or more of a polydiacetylene-based polymer and a polystyrene-based polymer, wherein the cross-linked polymer may have a functional group including one or more of a silane group, a phosphoric acid group, a thiol group, a carboxyl group, and an isocyanate group.

### CROSS-REFERENCE TO RELATED APPLICATION(S)

This application claims benefit of priority to Korean Patent Application No. 10-2024-0201938 filed on Dec. 31, 2024 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom. Such multilayer ceramic capacitors may be used as a component in various electronic devices due to having a small size, ensuring high capacitance and being easily mounted.

Recently, a method of coating a surface of a multilayer ceramic capacitor with a hydrophobic agent is being considered as one method for improving a moisture resistance reliability of a multilayer ceramic capacitors. A silane coupling agent is mainly used as the hydrophobic agent for coating multilayer ceramic capacitors, but research on the hydrophobic agent with improved thermal and chemical stability is needed to enhance a lifespan of the coating.

### DISCLOSURE

### Technical Problem

An aspect of the present disclosure is to provide a multilayer electronic component having excellent reliability.

However, problems to be solved by the present disclosure are not limited to the above, and will be more easily understood in the process of describing specific embodiments of the present disclosure.

### Solution to Problem

A multilayer electronic component according to an embodiment of the present disclosure may comprise: a capacitor including a ceramic body including a dielectric layer and internal electrodes alternately disposed with the dielectric layer interposed therebetween, and an external electrode disposed on the ceramic body and connected to the internal electrodes, and an organic layer disposed to cover at least a portion of an external surface of the capacitor and including a cross-linked polymer including one or more selected from the group consisting of a polydiacetylene-based polymer and a polystyrene-based polymer, wherein the cross-linked polymer may have a functional group including one or more selected from the group consisting of a silane group, a phosphoric acid group, a thiol group, a carboxyl group, and an isocyanate group.

A multilayer electronic component according to an embodiment of the present disclosure may comprise: a capacitor including a ceramic body including a dielectric layer and internal electrodes alternately disposed with the dielectric layer interposed therebetween, and an external electrode disposed on the ceramic body and connected to the internal electrodes, and an organic layer disposed to cover at least a portion of an external surface of the capacitor, the organic layer including a cross-linked polymer, the cross-linked polymer including a repeating unit derived from a self-assembled monolayer material, the self-assembled monolayer material including a head portion and a link portion connected to the head portion, the head portion including one or more selected from the group consisting of a silane group, a phosphate group, a thiol group, a carboxyl group, and an isocyanate group, wherein the link portion may have at least one carbon-carbon double bond.

### Advantageous Effects

According to an aspect of the present disclosure, multilayer electronic component with excellent moisture resistance reliability may be provided.

### BRIEF DESCRIPTION OF DRAWINGS

FIG. 1 is a perspective view schematically illustrating a multilayer electronic component according to an embodiment of the present disclosure.

FIG. 2 is a perspective view schematically illustrating a capacitor of the multilayer electronic component according to an embodiment of the present disclosure.

FIG. 3 schematically illustrates a cross-sectional view taken along line I-I′ of FIG. 1.

FIG. 4 schematically illustrates a cross-sectional view taken along line II-II′ of FIG. 1.

FIG. 5 is a schematic diagram illustrating a formation process of an organic layer.

FIGS. 6A to 6D are schematic diagrams illustrating an example of the formation process of the organic layer.

### DESCRIPTION OF REFERENCE CHARACTERS

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a first direction X may be defined as a thickness T direction, a second direction Y may be defined as a length L direction, and a third direction Z may be defined as a width W direction.

### Multilayer Electronic Component

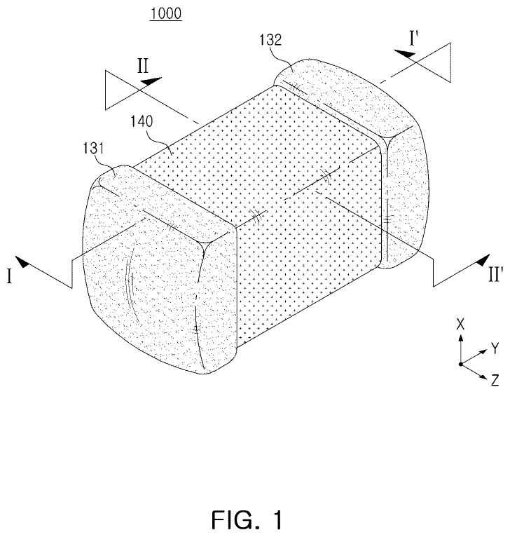

FIG. 1 is a perspective view schematically illustrating a multilayer electronic component according to an embodiment of the present disclosure.

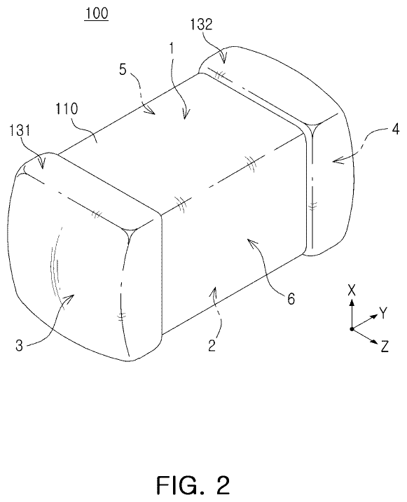

FIG. 2 is a perspective view schematically illustrating a capacitor of the multilayer electronic component according to an embodiment of the present disclosure.

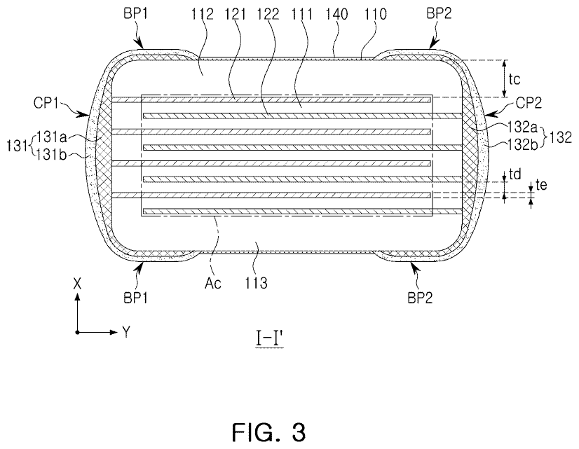

FIG. 3 schematically illustrates a cross-sectional view taken along line I-I′ of FIG. 1.

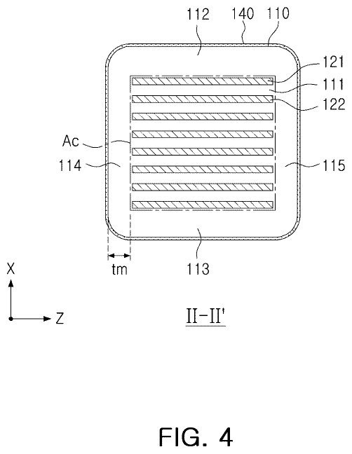

FIG. 4 schematically illustrates a cross-sectional view taken along line II-II′ of FIG. 1.

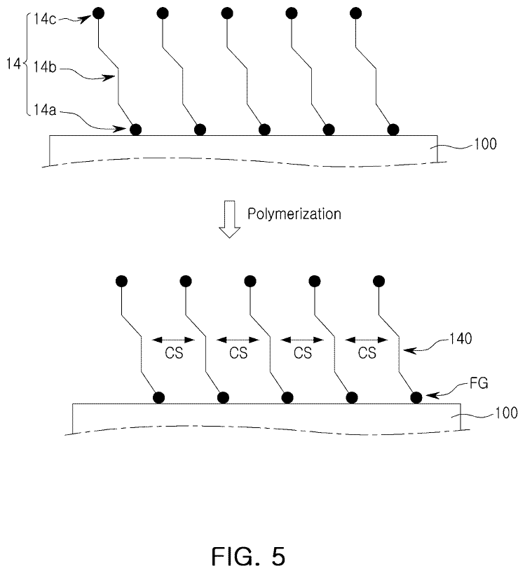

FIG. 5 is a schematic diagram illustrating a formation process of an organic layer.

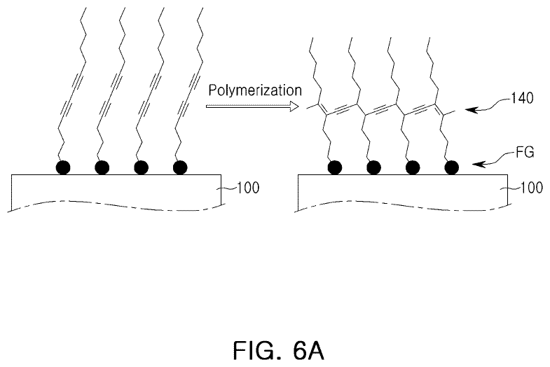

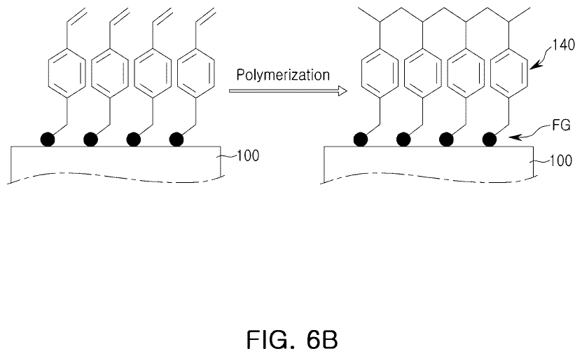

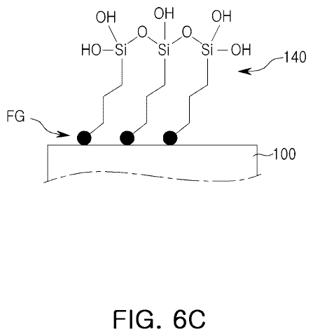

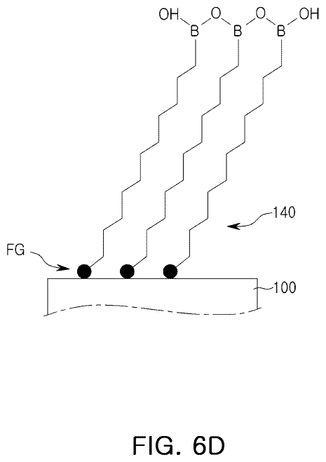

FIGS. 6A to 6D are schematic diagrams illustrating an example of the formation process of the organic layer.

Hereinafter, a multilayer electronic component 1000 according to an embodiment of the present disclosure will be described in detail with reference to FIGS. 1 to 6D. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

The size of the multilayer electronic component 1000 is not particularly limited, but a maximum length of the multilayer electronic component 1000 in the second direction may be 0.1 mm to 6.0 mm, a maximum width of multilayer electronic component 1000 in the third direction may be 0.1 mm to 5.0 mm, and a maximum thickness of the multilayer electronic component 1000 in the first direction maybe 0.05 mm to 3.5 mm.

The multilayer electronic component 1000 according to an embodiment of the present disclosure may include a capacitor 100 including a ceramic body 110 and external electrodes 131 and 132 and an organic layer 140.

The capacitor 100 may include the ceramic body 110 and external electrodes 131 and 132. The capacitor 100 may be a configuration performing a function of the multilayer electronic component 1000, for example, a function for forming capacitance.

There is no particular limitation on a specific shape of the ceramic body 110, but as illustrated, the ceramic body 110 may have a hexahedral shape or a shape similar thereto. Due to shrinkage of ceramic powder particles included in the body 110 during a sintering process or due to the polishing process for a corner portion of the body 110, the body 110 may not have a hexahedral shape with entirely straight lines, but may have a substantially hexahedral shape.

The ceramic body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The ceramic body 110 may include a dielectric layer 111 and internal electrodes 121 and 122 disposed alternately with the dielectric layer 111 in the first direction. A plurality of dielectric layers 111 forming the ceramic body 110 is in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O3 (0<x<1, 0<y<1), Ba(Ti_{1-y}Zr_{y})O₃ (0<y<1), CaZrO₃ and (Ca₁₋ₓSrₓ)(Zr_{1-y}Ti_{y})O₃ (0<x≤0.5, 0<y≤0.5).

An average thickness td of the dielectric layer 111 is not particularly limited. The average thickness td of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

The internal electrodes 121 and 122 may include, for example, a first internal electrode 121 and a second internal electrode 122 that are alternately disposed in the first direction with the dielectric layer 111 interposed therebetween. The first internal electrode 121 and the second internal electrode 122, a pair of electrodes having different polarities, may be disposed opposing each other with the dielectric layer 111 therebetween.

The first internal electrode 121 may be spaced apart from the fourth surface 4 and may be connected to the first external electrode 131 on the third surface 3. The second internal electrode 122 may be spaced apart from the third surface 3 and may be connected to the second external electrode 132 on the fourth surface 4.

A conductive metal included in the internal electrodes 121 and 122 may be one or more selected from the group consisting of Ni, Cu, Pd, Ag, Au, Pt, Sn, W, Ti, and alloys thereof, and more preferably, the internal electrodes 121 and 122 may include Ni, but the present disclosure is not limited thereto.

An average thickness te of the internal electrodes 121 and 122 is not particularly limited. The average thicknesses te of the internal electrodes 121 and 122 may be, for example, 0.1 μm to 3.0 μm, 0.1 μm to 1.0 μm, or 0.1 μm to 0.4 μm.

The average thickness td of the dielectric layer 111 and the average thickness te of the internal electrodes 121 and 122 respectively refer to average thicknesses of the dielectric layer 111 and the internal electrodes 121 and 122 in the first direction. The average thickness td of the dielectric layer 111 and the average thickness te of the internal electrodes 121 and 122 may be measured by scanning a cross section of the ceramic body 110 in the first and second direction with a scanning electron microscope SEM of 10,000× magnification.

More specifically, the average thickness td of the dielectric layer 111 may be measured by calculating the average after measuring the thickness at a plurality of points of one dielectric layer 111, for example, at 5 points equally spaced apart from each other in the second direction, and then taking the average value. In addition, the average thicknesses te of the internal electrodes 121 and 122 may be measured by calculating the average after measuring the thicknesses at a plurality of points of one internal electrode 121 and 122, for example, at 5 points equally spaced apart from each other in the second direction. The 5 points equally spaced apart from each other may be designated in a capacitance formation portion Ac.

Meanwhile, when the average value measurements are performed for each of 10 dielectric layers 111 and 10 internal electrodes 121 and 122, and then the average values may be calculated, the average thickness td of the dielectric layer 111 and the average thicknesses te of the internal electrodes 121 and 122 may be further generalized.

The ceramic body 110 may include a capacitance formation portion Ac, in which capacitance is formed by the first and second internal electrodes 121 and 122 alternately disposed with a dielectric layer 111 interposed therebetween, and cover portions 112 and 113 disposed on opposite surfaces of the capacitance formation portion AC in the first direction. The cover portions 112 and 113 may have a similar configuration to the dielectric layer 111 except for not including the internal electrode.

An average thicknesses tc of the cover portions 112 and 113 may not be particularly limited. The average thickness tc of the cover portions 112 and 113 may be, for example, 150 μm or less, 100 μm or less, 30 μm or less or 20 μm or less. The average thicknesses tc of the cover portions 112 and 113 may be, for example, 5 μm or more, 10 μm or more, or 30 μm or more. In this case, the average thicknesses tc of the cover portions 112 and 113 may refer to an average thickness of each of the first cover portion 112 and the second cover portion 113.

The average thickness tc of the cover portions 112 and 113 may refer to an average thickness of the cover portions 112 and 113 in the first direction, and may be an average value of thicknesses in the first direction measured at 5 points equally spaced apart from each other in a cross-section of the ceramic body 110 in the first and second directions.

The ceramic body 110 may include margin portions 114 and 115 disposed on opposite surfaces of the capacitance formation portion Ac in the third direction. The margin portions 114 and 115 may refer to a region between both ends of the internal electrodes 121 and 122 and a boundary surface of the ceramic body 110 in a cross-section of the ceramic body 110 in the first direction and the third direction. The margin portions 114 and 115 may have a similar configuration to the dielectric layer 111 except for not including the internal electrodes 121 and 122.

An average thickness tm of the margin portions 114 and 115 is not particularly limited. The average thickness tm of the margin portions 114 and 115 may be, for example, 100 μm or less, 20 μm or less, or 15 μm or less. The average thickness tm of the margin portions 114 and 115 may be, for example, 5 μm or more or 10 μm or more. In this case, the average thickness tm of the margin portions 114 and 115 refers to an average thickness of each of a first margin portion 114 and a second margin portion 115.

The average thickness tm of the margin portions 114 and 115 may refer to an average thickness of the margin portions 114 and 115 in the third direction, and may be an average value of thicknesses in the third direction measured at 5 points equally spaced apart from each other in a cross-section of the ceramic body 110 in the first and third directions.

External electrodes 131 and 132 may be disposed on the ceramic body 110 and connected to the internal electrodes 121 and 122. For example, the external electrodes 131 and 132 may be disposed on the third and fourth surfaces 3 and 4 of the ceramic body 110, respectively, and may extend onto a portion of the first, second, fifth and sixth surfaces 1, 2, 5, and 6. The external electrodes 131 and 132 may include a first external electrode 131 disposed on the third surface 3 and connected to the first internal electrode 121, and a second external electrode 132 disposed on the fourth surface 4 and connected to the second internal electrode 122.

The external electrodes 131 and 132 may include connection portions CP1 and CP2 disposed on the third or fourth surface 3 or 4, respectively, and band portions BP1 and BP2 extending from the connection portions CP1 and CP2 onto the first and second surfaces 1 and 2. The first external electrode 131 may include a first connection portion CP1 disposed on the third surface 3, and a first band portion BP1 extending from the first connection portion CP1 onto the first and second surfaces 1 and 2. The second external electrode 132 may include a second connection portion CP2 disposed on the fourth surface 4, and a second band portion BP2 extending from the second connection portion CP2 onto the first and second surfaces 1 and 2. The band portions BP1 and BP2 may be extending from the connecting portions CP1 and CP2 onto the fifth and sixth surfaces 5 and 6.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, at least one selected from the group consisting of Cu, Ni, Pd, Pt, Au, Ag, Pb, and/or alloys thereof. The glass included in the base electrode layers 131a and 132a may include, for example, one or more oxides selected from the group consisting of Ba, Ca, Zn, Al, B, and Si.

Meanwhile, the base electrode layers 131a and 132a may be configured by only the sintered electrode layer, but the present disclosure may not be limited thereto, and the base electrode layers 131a and 132a may include, a sintered electrode layer including metal and glass, and a resin electrode layer disposed on the sintered electrode layer and including metal particles and resin.

The metal particles included in the resin electrode layer may include one or more selected from the group consisting of spherical particles and flake-shaped particles. The metal particles included in the resin electrode layer may include, for example, at least one selected from the group consisting of Cu, Ni, Pd, Pt, Au, Ag, Pb, Sn and alloys thereof. The resin included in the resin electrode layer may include, for example, one or more selected from the group consisting of epoxy resin, acrylic resin, and ethyl cellulose.

The plating layers 131b and 132b may include, for example, at least one selected from the group consisting of Ni, Sn, Pd and alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. The plating layers 131b and 132b may include a plurality of Ni plating layers and/or a plurality of Sn plating layers.

Although the drawing describes a structure in which a multilayer electronic component 1000 has two external electrodes 131 and 132, it may not be limited thereto, and the number or shape of the external electrodes 131 and 132 may be changed depending on shapes of the internal electrodes 121 and 122 or other purposes.

The multilayer electronic component 1000 may include an organic layer 140 disposed to cover at least a portion of an external surface of the capacitor 100. For example, the organic layer 140 may be disposed to cover at least a portion of an external surface of the ceramic body 110. The organic layer 140 may be disposed, for example, at least one of the first, second, fifth and sixth surfaces 1, 2, 5, and 6. The organic layer 140 may be continuously disposed on, for example, the first, second, fifth and sixth surfaces 1, 2, 5, and 6.

In an embodiment, the organic layer 140 may be disposed in direct contact with the external surface of the ceramic body 110. The organic layer 140 may be disposed to be in direct contact with at least one of the first, second, fifth and sixth surfaces 1, 2, 5, and 6. The first organic layer 140 may be disposed to be in direct contact with the first, second, fifth and sixth surfaces 1, 2, 5, and 6, respectively.

The organic layer 140 may be disposed to cover only a portion of the external surface of the ceramic body 110, but in order to more effectively improve the moisture resistance reliability of the multilayer electronic component 1000, the organic layer 140 may be disposed to completely cover a region of the external surface of the ceramic body 110 that is not covered by the external electrodes 131 and 132. In this case, the region of the external surface of the ceramic body 110 that is not covered by the external electrodes 131 and 132 may refer to, for example, a region of the ceramic body 110 exposed to the outside between the first band portion BP1 and the second band portion BP2.

Meanwhile, in the present disclosure, only a structure in which the organic layer 140 is disposed to cover the external surface of the ceramic body 110 is illustrated, but the present disclosure is not limited thereto. For example, the organic layer 140 may be disposed to cover at least a portion of an external surface of the external electrodes 131 and 132. Additionally, the organic layer 140 may be disposed to cover at least a portion of the external surface of the ceramic body 110 and at least a portion of the external surface of the external electrodes 131 and 132, respectively. Additionally, the organic layer 140 may be disposed to completely cover an external surface of the capacitor 100. Additionally, the organic layer 140 may be disposed in an island shape on the external surface of the capacitor 100. Additionally, the organic layer 140 may include a first organic layer disposed to cover at least a portion of the external surface of the ceramic body 110 and a second organic layer disposed to cover at least a portion of the external electrodes 131 and 132. Additionally, the organic layer 140 may have a multilayer structure configured by a plurality of layers.

The organic layer 140 may include a cross-linked polymer. In the present disclosure, the term “cross-linked polymer” may refer to a polymer including a structure in which specific repeating units are cross-linked. The cross-linked polymer may include, for example, one or more selected from the group consisting of a polydiacetylene-based polymer and a polystyrene-based polymer. However, the present disclosure is not limited thereto, and the cross-linked polymer may include one or more selected from the group consisting of a polydiacetylene-based polymer, a polystyrene-based polymer, a silane-based cross-linked polymer, and a boronic acid-based cross-linked polymer.

The cross-linked polymer may have a functional group including one or more selected from the group consisting of a silane group, a phosphoric acid group, a thiol group, a carboxyl group, and an isocyanate group. Through the functional group, the organic layer 140 may be stably formed on the external surface of the capacitor 100, thereby improving the thermal stability and chemical stability of the organic layer 140.

Specifically, the functional group may be present at an end portion close to the capacitor 100 of the cross-linked polymer. In this case, the functional group may chemically bond with the external surface of the capacitor 100. The chemical bond between the functional group and the external surface of the capacitor 100 may be, for example, a covalent bond. That is, the organic layer 140 may be chemically adsorbed on the external surface of the capacitor 100.

The functional group of the cross-linked polymer may be appropriately determined in consideration of the main component of the external surface of the capacitor 100, on which the organic layer 140 is disposed, for thermal stability and chemical stability of the organic layer 140. For example, the main component configuring the external surface of the ceramic body 110 may be ceramic, and a main component configuring the external surface of the external electrodes 131 and 132 may be metal. When the organic layer 140 is disposed to cover the external surface of the ceramic body 110, the functional group may include one or more selected from the group consisting of the silane group and the phosphoric acid group. The silane group and phosphate group may have a stronger bonding strength with ceramics than with metals. Additionally, when the organic layer 140 is disposed to cover the external surface of the external electrodes 131 and 132, the functional group may include a thiol group. The thiol group may have a stronger bonding strength with metals than with ceramics.

The cross-linked polymer may include, for example, a repeating unit derived from a self-assembling monolayer material 14. The repeating unit derived from a self-assembled monolayer material 14 may refer to a repeating unit having a structure obtained by polymerizing the self-assembled monolayer material 14. More specifically, the cross-linked polymer included in the organic layer 140 may be formed through cross-linking bonds CS between the self-assembled monolayer materials 14.

The self-assembled monolayer material 14 may refer to a molecular structure of a self-assembled monolayer that is spontaneously aligned and formed on the surface of the capacitor 100. The self-assembled monolayer material 14 may include a head portion 14a and a link portion 14b connected to the head portion 14a. The link portion 14b may include a tail portion 14c disposed at the end of the link portion 14b.

The head portion 14a may include one or more selected from the group consisting of a silane group, a phosphoric acid group, a thiol group, a carboxyl group, and an isocyanate group. In this case, the head portion 14a may be chemically bonded to the surface of the capacitor 100. The head portion 14a may correspond to a functional group FG of the cross-linked polymer.

The link portion 14b may function to align each self-assembled monolayer material 14 and having hydrophobicity, thereby providing hydrophobic performance. The link portion 14b may have at least one carbon-carbon double bond to form the cross-linking bonds CS between self-assembled monolayer materials 14. Types of link portion 14b are not particularly limited, but may include, for example, one of more selected from the group consisting of: an aliphatic compound having at least one carbon-carbon double bond and containing five or more carbon atoms; and an aromatic compound having at least one carbon-carbon double bond.

The tail portion 14c may have, for example, a hydrophobic functional group to improve the moisture resistance reliability of the multilayer electronic component 1000. The tail portion 14c may include, for example, one or more selected from the group consisting of a substituted or unsubstituted C2 to C10 alkene group, a substituted or unsubstituted phenyl group, halogen groups F, Cl, Br, and I, and a nitro group.

That is, the organic layer 140 may be a cross-linked self-assembled monolayer. In this case, the thermal stability and chemical stability of the organic layer 140 may be more effectively improved.

For example, as illustrated in FIG. 6A, the self-assembled monolayer material may be a diacetylene compound. The cross-linked polymer formed through the cross-linking bonds between the diacetylene-based self-assembled monolayer materials may include a polydiacetylene-based polymer. The organic layer 140 may include the polydiacetylene-based polymer having a functional group FG of one or more selected from the group consisting of the silane group, phosphoric acid group, thiol group, carboxyl group, and isocyanate group.

For example, as illustrated in FIG. 6B, the self-assembled monolayer material may be a styrene-based compound. The cross-linked polymer formed through the cross-linking bonds between the styrene-based self-assembled monolayer materials may include the polydiacetylene-based polymer. The organic layer 140 may include the polydiacetylene-based polymer having a functional group FG of one or more selected from the group consisting of the silane group, phosphoric acid group, thiol group, carboxyl group, and isocyanate group.

For example, as illustrated in FIG. 6C, the self-assembled monolayer material may be the silane-based compound. The cross-linked polymer formed through the cross-linking bonds between the silane-based self-assembled monolayer materials may include a silane-based cross-linked polymer. The organic layer 140 may include the silane-based cross-linked polymer having the thiol group as the functional group FG. The organic layer 140 may include, for example, silane-based alkanethiols.

For example, as illustrated in FIG. 6D, the self-assembled monolayer material may be a boronic acid-based compound. The cross-linked polymer formed through the cross-linking bonds between the boronic acid-based self-assembled monolayer materials may include a boronic acid-based cross-linked polymer. The organic layer 140 may include the boronic acid-based cross-linked polymer having the thiol group as the functional group FG. The organic layer 140 may include, for example, boronic acid-based alkanethiols.

Meanwhile, the presence, types, and characteristics of organic materials included in the organic layer 140 may be measured using techniques such as infrared absorption spectrum, ultraviolet/visible absorption spectrum, mass spectrum MS, 1H NMR spectrum, etc., but are not limited thereto, and may be measured using general analytical methods widely used in the art.

Hereinafter, an example of a method for forming the multilayer electronic component 1000 will be described. However, the manufacturing method of the multilayer electronic component 100 is not limited thereto.

First of all, ceramic powder for forming a dielectric layer 111 are prepared. The ceramic powder may include, for example, one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O3 (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). The method for synthesizing the ceramic powder, BaTiO₃, may include, for example, a solid phase method, a sol-gel method, a hydrothermal synthesis method, or the like, but the present disclosure is not limited thereto. Next, the prepared ceramic powder are dried and ground, and then an organic solvent such as ethanol, and a binder such as polyvinyl butyral, or the like are mixed to prepare a ceramic slurry, and then the ceramic slurry is applied and dried on a carrier film to prepare a ceramic green sheet.

Next, conductive paste for an internal electrode containing metal powder, a binder, an organic solvent, or the like is printed onto the ceramic green sheet to a predetermined thickness using a screen-printing method, or a gravure printing method, thereby forming an internal electrode pattern.

Thereafter, the ceramic green sheet having the internal electrode pattern printed thereon is peeled off from the carrier film, and then the ceramic green sheet having the internal electrode pattern printed in a predetermined amount of layers are multilayered and pressed to form ceramic multilayer. On the upper and lower portions of the ceramic multilayer, a ceramic green sheet without an internal electrode pattern formed may be multilayered in a predetermined amount of layers to form the cover portions 112 and 113 after sintering. Thereafter, the ceramic multilayer may be cut to have a predetermined size of chip, and the cut chip may be sintered at a temperature of 1000° C. or higher and 1400° C. or lower to form the ceramic body 110.

Meanwhile, the margin portions 114 and 115 may be formed by applying and sintering the conductive paste for the internal electrode except for a region in which the margin portion is to be formed on the ceramic green sheet. Alternatively, in order to suppress the step by the internal electrodes 121 and 122, the ceramic multilayer may be cut such that the internal electrode pattern is exposed on both surfaces of the cut chip in the third direction, and then a sheet for forming the margin portion may be attached on both surfaces of the cut chip in the third direction and sintered to form the margin portions 114 and 115.

Next, external electrodes 131 and 132 may be formed. For example, when the base electrode layers 131a and 132a include a sintered electrode layer, the ceramic body 110 may be dipped in an external electrode conductive paste including metal powder, glass frit, a binder, and an organic solvent, and then the external electrode conductive paste may be sintered at a temperature of 500° C. to 900° C. to form a sintered electrode layer.

For example, when the base electrode layers 131a and 132a includes a resin electrode layer, the body may be dipped in a conductive resin composition including metal powder, resin, binder, and organic solvent, and then cured and heat-treated at a temperature of 250° C. to 550° C. to form the resin electrode layer.

In addition, an electrolytic plating method and/or an electroless plating method may be further performed to form the plating layers 131b and 132b on the base electrode layers 131a and 132a.

Next, the self-assembled monolayer material 14 may be coated on the capacitor 100 by using a liquid phase deposition method or a vapor phase deposition method. The head portion 14a of the self-assembled monolayer material 14 may chemically bond to a surface of the capacitor 100, thereby forming a self-assembled monolayer on an external surface of the capacitor 100.

The self-assembled monolayer material 14 may be, for example, a diacetylene-based, styrene-based, silane-based and/or boronic acid-based compound containing one or more selected from the group consisting of a silane group, a phosphoric acid group, a thiol group, a carboxyl group and an isocyanate group as the head portion 14a.

Next, the organic layer 140 may be formed by cross-linking the self-assembled monolayer material 14 forming the self-assembled monolayer to form the cross-linked polymer. Polymerization by the cross-linking bond may be initiated through photopolymerization via UV and/or radical polymerization via, but the present disclosure is not limited thereto. The cross-linked polymer may be self-crosslinked, but the present disclosure is not limited thereto.

In order to directly coat the polymer onto the capacitor 100, precise control and complex equipment/facilities may be needed. According to the present disclosure, a self-assembled monolayer material 14 may be coated on the capacitor 100 in a relatively simple method. A simple monolayer may have a minimal effect in improving the moisture resistance reliability of the multilayer electronic component 1000, but by forming a cross-linked polymer with excellent water-repelling effect through cross-linking bonds of single molecules forming the monolayer, the moisture resistance reliability of the multilayer electronic component 1000 may be effectively improved.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. In addition, the terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

While the embodiments have been illustrated and described above, it will be configured as apparent to those skilled in the art that modifications and variations could be made without departing from the scope of the present disclosure as defined by the appended claims.

1. A multilayer electronic component comprising:
a capacitor comprising a ceramic body including a dielectric layer and internal electrodes alternately disposed with the dielectric layer interposed therebetween, and an external electrode disposed on the ceramic body and connected to the internal electrodes; and
an organic layer disposed to cover at least a portion of an external surface of the capacitor, the organic layer including a cross-linked polymer including one or more selected from the group consisting of a polydiacetylene-based polymer and a polystyrene-based polymer,
wherein the cross-linked polymer includes a functional group including one or more selected from the group consisting of a silane group, a phosphoric acid group, a thiol group, a carboxyl group, and an isocyanate group.

2. The multilayer electronic component of claim 1, wherein the cross-linked polymer includes a repeating unit derived from a self-assembled monolayer material.

3. The multilayer electronic component of claim 2, wherein the self-assembled monolayer material includes a head portion and a link portion connected to the head portion,
wherein the head portion includes the functional group,
wherein the link portion includes at least one carbon-carbon double bond.

4. The multilayer electronic component of claim 1, wherein the organic layer comprises a cross-linked self-assembled monolayer.

5. The multilayer electronic component of claim 1, wherein the functional group chemically bonds with the external surface of the capacitor.

6. The multilayer electronic component of claim 1, wherein the organic layer is disposed to be in direct contact with the external surface of the capacitor.

7. The multilayer electronic component of claim 1, wherein the organic layer is disposed to cover at least a portion of an external surface of the ceramic body.

8. The multilayer electronic component of claim 1, wherein the organic layer is disposed to completely cover a region of the external surface of the ceramic body not covered by the external electrode.

9. The multilayer electronic component of claim 7, wherein the functional group includes one or more selected from the group consisting of a silane group and a phosphoric acid group.

10. A multilayer electronic component further comprising:
a capacitor including a ceramic body including a dielectric layer and internal electrodes alternately disposed with the dielectric layer interposed therebetween, and an external electrode disposed on the ceramic body and connected to the internal electrodes; and
an organic layer disposed to cover at least a portion of an external surface of the capacitor, the organic layer including a cross-linked polymer,
wherein the cross-linked polymer includes a repeating unit derived from a self-assembled monolayer material,
wherein the self-assembled monolayer material includes a head portion and a link portion connected to the head portion,
wherein the head portion includes one or more selected from the group consisting of a silane group, a phosphate group, a thiol group, a carboxyl group, and an isocyanate group, and the link portion has at least one carbon-carbon double bond.

11. The multilayer electronic component of claim 10, wherein the organic layer is disposed to cover at least a portion of an external surface of the ceramic body.

12. The multilayer electronic component of claim 10, wherein the organic layer is disposed to completely cover a region of the external surface of the ceramic body not covered by the external electrode.

13. The multilayer electronic component of claim 11, wherein the head portion includes one or more selected from the group consisting of a silane group and a phosphoric acid group.
